(19) United States
(12) Patent Application Publication
(10) Pub. No.: US 2026/0330118 A1
(43) Pub. Date: Oct. 22, 2026

(54) METHOD, DEVICE, AND SYSTEM WITH SEMICONDUCTOR PATTERN IMAGE GENERATION

(71) Applicant: Samsung Electronics Co., Ltd., Suwon-si (KR)

(72) Inventors: Seong-Jin PARK, Suwon-si (KR); Haedong JEONG, Suwon-si (KR); Seungju SHIN, Suwon-si (KR); Jaewon YANG, Suwon-si (KR); Seon Min RHEE, Suwon-si (KR)

(73) Assignee: Samsung Electronics Co., Ltd., Suwon-si (KR)

(21) Appl. No.: 19/468,124

(22) Filed: Feb. 3, 2026

(30) Foreign Application Priority Data
Feb. 7, 2025 (KR) 10-2025-0016188

(51) Int. Cl. G06F 30/392; G03F 7/00

(52) U.S. Cl. CPC G06F 30/392; G03F 7/70433

(57) ABSTRACT

A device including one or more processors including processing circuitry and a memory including one or more storage media storing instructions that, when executed individually or collectively by the one or more processors, cause the electronic device to convert a patterning vulnerability into a first vector, convert a design rule into a second vector, and generate one or more pattern images to satisfy the patterning vulnerability and the design rule based on the first vector and the second vector.

### CROSS-REFERENCE TO RELATED APPLICATION

This application claims priority to and the benefit of Korean Patent Application No. 10-2025-0016188 filed with the Korean Intellectual Property Office on Feb. 07, 2025, the entire contents of which are incorporated herein by reference.

### BACKGROUND OF THE INVENTION

### a. Field of the Invention

The present disclosure relates to a method, device, and system with semiconductor pattern image generation. More particularly, the present disclosure relates to a device, method, and system with semiconductor pattern image generation including receiving design rules and patterning a vulnerability to generate semiconductor pattern images.

### b. Description of the Related Art

Typical methods for generating semiconductor pattern images may allow engineers to directly make semiconductor pattern image candidate groups for semiconductor process simulations or the semiconductor pattern image candidate groups may be obtained according to a rule-based method.

In the case of directly making the semiconductor pattern image candidate groups, a deviation (reduction of diversity) of quality of results may be large according to expertise of the maker, and generation rates may be inefficient (Low diversity & High cost & High fidelity). The rule-based method may set an upper-bound of diversity depending on the complexity of the rules for designing the semiconductor patterns (Middle diversity & Middle cost & Low fidelity). In addition, the semiconductor pattern images generated based on rule-based methods may have low accuracy/fidelity.

That is, the quality of the patterning candidate group typically depends on the expertise of engineers. In addition, typically making semiconductor pattern image candidate groups may result in slow manufacturing rates which may be expensive to perform. In addition, there may be a limit on the diversity of the semiconductor pattern images that can be manufactured as that diversity may be based on the complexity of the rule employed in typical rule-based methods.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided an electronic device including one or more processors including processing circuitry and a memory including one or more storage media storing instructions that, when executed individually or collectively by the one or more processors, cause the electronic device to convert a patterning vulnerability into a first vector, convert a design rule into a second vector, and generate one or more pattern images to satisfy the patterning vulnerability and the design rule based on the first vector and the second vector.

The converting of the patterning vulnerability into the first vector may include determining a first weak score from the patterning vulnerability using a patterning vulnerability estimating index, the patterning vulnerability estimating index being one of a process variation band (PVB) and a normalized image log slope (NILS) and calculating a vector value corresponding to the determined first weak score.

The calculating of the vector value may include defining classes by quantizing one or more class weak scores, the class weak scores being defined as continuous values, defining a codebook including class vector values corresponding to the classes, and determining a first weak score and a corresponding first vector based on the codebook.

The defining classes may include defining an unknown class responsive to an absence of the patterning vulnerability to generate a default vector as the vector value.

The converting of the patterning vulnerability into the first vector may include simultaneously receiving proposed weak scores as patterning vulnerabilities, the proposed weak scores being created using patterning vulnerability estimating indices.

The execution of the instructions may cause the electronic device to receive the design rules for respective polygons included in the one or more pattern image and project the design rule in a predetermined dimension to generate the second vector.

The generating may include generating polygons respectively satisfying the design rule and generating patterns defined by an arrangement of the polygons and reflecting the patterning vulnerability.

The generating may include generating the one or more pattern images using an artificial intelligence-based image generating model.

The generating may include generating the one or more pattern images satisfying the patterning vulnerability and the design rule from random noise using a diffusion model.

In a general aspect, here is provided a processor-implemented method including converting a received patterning vulnerability into a first vector, converting a received design rule into a second vector, and generating one or more pattern images satisfying the patterning vulnerability and the design rule with the first vector and the second vector.

The converting of the received patterning vulnerability may include determining a first weak score from the received patterning vulnerability using a patterning vulnerability estimating index, the patterning vulnerability estimating index being one of a process variation band (PVB) and a normalized image log slope (NILS) and calculating a vector value corresponding to the determined first weak score.

The calculating may include defining classes by quantizing one or more class weak scores, the class weak scores being defined as continuous values, defining a codebook including class vector values corresponding to the classes, and determining a first weak score and a corresponding first vector based on the codebook.

The defining of the classes may include defining an unknown class responsive without the received patterning vulnerability to generate a default vector as the vector value.

The converting of the received patterning vulnerability into the first vector may include simultaneously receiving proposed weak scores as received patterning vulnerabilities, the proposed weak scores being created using patterning vulnerability estimating indices.

The converting of the received design rule into the second vector may include receiving the design rules for respective polygons included in the one or more pattern images and projecting the design rule in a predetermined dimension to generate the second vector.

The generating may include generating polygons respectively satisfying the received design rule and generating patterns defined by an arrangement of the polygons and reflecting the patterning vulnerability.

The generating may include generating the one or more pattern image using an artificial intelligence-based image generating model.

The generating may include generating the one or more pattern images satisfying the received patterning vulnerability and the received design rule from random noise using a diffusion model.

In a general aspect, here is provided a system including a semiconductor pattern image generator configured to generate semiconductor pattern images, the semiconductor pattern image generator including an artificial intelligence model for generating a patterning candidate group including at least one pattern image satisfying a design rule and a patterning vulnerability and a simulator for performing a process simulation using the patterning candidate group, the system being configured to adjust process variables responsive to results of the simulation.

The semiconductor pattern image generator may include one or more processors including processing circuitry and a memory including one or more storage media storing instructions that, when executed individually or collectively by the one or more processors, cause the semiconductor pattern image generator to convert a patterning vulnerability into a first vector, convert a design rule into a second vector, generate one or more pattern images to satisfy the patterning vulnerability and the design rule based on the first vector and the second vector, and generate, though an artificial intelligence-based model, one or more semiconductor pattern images.

### BRIEF DESCRIPTION OF THE DRAWINGS

FIG. 1 illustrates an example process with semiconductor pattern image generation according to one or more embodiments.

FIG. 2 illustrates an example device with semiconductor pattern image generation according to one or more embodiments.

FIG. 3 illustrates an example patterning vulnerability embedder of FIG. 2 according to one or more embodiments.

FIG. 4 illustrates an example design rule embedder of FIG. 2 according to one or more embodiments.

FIG. 5 illustrates example inputs and outputs according to one or more embodiments.

FIGS. 6A and FIG. 6B illustrate example devices with semiconductor pattern image generation according to one or more embodiments.

FIG. 7 illustrates an example method with semiconductor pattern image generation according to one or more embodiments.

FIG. 8 illustrates an example electronic device according to one or more embodiments.

Throughout the drawings and the detailed description, unless otherwise described or provided, the same, or like, drawing reference numerals may be understood to refer to the same, or like, elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term "may" herein with respect to an example or embodiment (e.g., as to what an example or embodiment may include or implement) means that at least one example or embodiment exists where such a feature is included or implemented, while all examples are not limited thereto. The use of the terms "example", "embodiment", and "example embodiment" herein have a same meaning (e.g., the phrasing 'in an or one example' has a same meaning as 'in an or one embodiment" and 'in an or one example embodiment'), and "one or more examples" has a same meaning as "one or more embodiments" and "one or more example embodiments". Still further, each of multiple or all separately described an/one "example", "embodiment", "example embodiment", as well as "examples", "embodiments", "example embodiments", herein may be included, in combination, in a same embodiment in any combination.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

As used in connection with various example embodiments of the disclosure, any use of the terms "module" or "unit" means hardware and/or processing hardware configured to implement software and/or firmware to configure such processing hardware to perform corresponding operations, and may interchangeably be used with other terms, for example, "logic," "logic block," "part," or "circuitry". As one non-limiting example, an application-predetermined integrated circuit (ASIC) may be referred to as an application-predetermined integrated module. As another non-limiting example, a field-programmable gate array (FPGA) or an application-specific integrated circuit (ASIC) may be respectively referred to as a field-programmable gate unit or an application-specific integrated unit. In a non-limiting example, such software may include components such as software components, object-oriented software components, class components, and may include processor task components, processes, functions, attributes, procedures, subroutines, segments of the software. Software may further include program code, drivers, firmware, microcode, circuits, data, database, data structures, tables, arrays, and variables. In another non-limiting example, such software may be executed by one or more central processing units (CPUs) of an electronic device or secure multimedia card.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

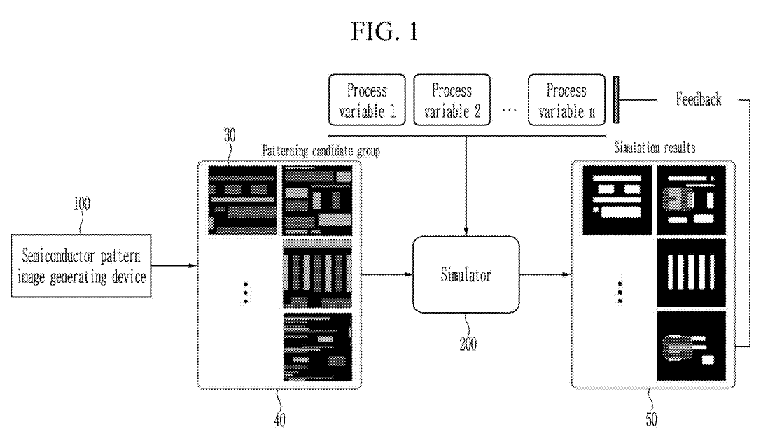

FIG. 1 illustrates an example process with semiconductor pattern image generation according to one or more embodiments.

Referring to FIG. 1, a system with semiconductor pattern image generation may include a device that generates semiconductor pattern images 100 and a simulator 200.

The device 100 may generate a patterning candidate group 40 including at least one pattern image 30 that satisfies input design rules and a patterning vulnerability.

The device 100 may generate the patterning candidate group 40 which satisfies the design rule and the patterning vulnerability when the design rules and the patterning vulnerability are input.

In an example, the simulator 200 may receive the generated patterning candidate group 40, and may perform a semiconductor process simulation using the patterning candidate group 40.

The simulator 200 may output simulation results 50 through repeated semiconductor process simulations.

The system for generating semiconductor pattern images may adjust process variables through feedback using the device for generating semiconductor pattern images 100 and the simulation results 50 obtained by the simulator 200.

The system for generating semiconductor pattern images may repeat the semiconductor process simulation using the adjusted process variables and may determine validity of the process.

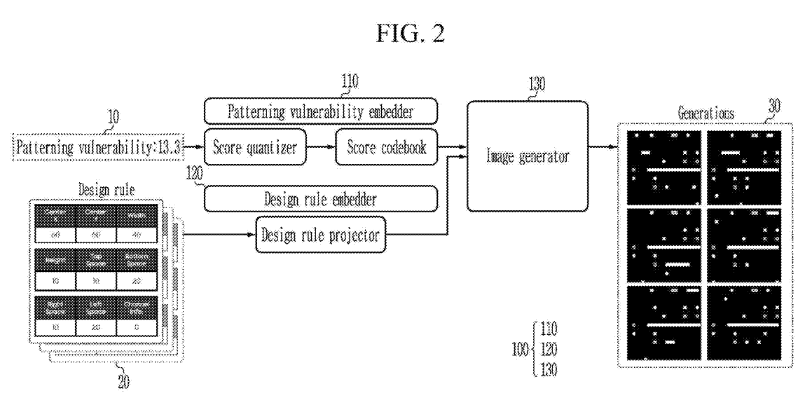

FIG. 2 illustrates an example device with semiconductor pattern image generation according to one or more embodiments.

Referring to FIGS. 1 and 2, the device 100 may execute a program code or an instruction loaded on at least one memory device through at least one processor.

For example, the device 100 may be implemented as an electronic device 900 to be described in greater detail below with reference to FIG. 9. The at least one processor may correspond to a processor 910 of the electronic device 900, and the at least one memory device may correspond to a memory 930 of the electronic device 900.

The program code or the instruction may be executed by at least one processor, and may generate at least one pattern image satisfying the design rule and the patterning vulnerability as a patterning candidate group input to the semiconductor process simulation.

Referring to FIG. 2, in a non-limiting example, the device with semiconductor pattern image generation 100 of FIG. 1 may include a patterning vulnerability embedder 110, a design rule embedder 120, and an image generator 130.

In an example, the patterning vulnerability embedder 110 may receive a patterning vulnerability (e.g., patterning vulnerability 10) and may convert the same into a first vector. For example, the patterning vulnerability 10 may be an estimation index for predicting a patterning validity of actual processes according to the designed process simulation. That is, the patterning vulnerability 10 may be an index for determining a success state of the simulation result. The patterning vulnerability 10 may be calculated using various indices including a process variation band (PVB), a normalized image log slope (NILS), etc.

In an example, the patterning vulnerability embedder 110 may receive the patterning vulnerability 10. Next, the patterning vulnerability 10 may be assessed as a score for use in a model using one or more patterning vulnerability estimating indices, such as the PVB or NILS indices. That is, the patterning vulnerability 10 may be translated into a weak score based on the indices, as described in greater detail below, so as to be usable by a neural network model. Upon receiving the weak score, the embedder 10 may convert that weak score into a vector value.

That is, the patterning vulnerability embedder 110 may receive the patterning vulnerability 10 which may then be assessed, by the patterning vulnerability estimating index-based, into a weak score, and a vector value may be calculated that corresponds to the weak score. For example, in FIG. 2, an example value for the weak score is illustrated to be a value of 13.3 (i.e., in the patterning vulnerability 10 element).

The patterning vulnerability embedder 110 may provide the first vector to an artificial intelligence model of the image generator 130 as an input.

In an example, the patterning vulnerability embedder 110 may simultaneously receive the respective weak scores as patterning vulnerabilities using the patterning vulnerability estimating indices. That is, the patterning vulnerability embedder 110 may receive a PVB-based first weak score and a NILS-based second weak score.

In an example, the design rule embedder 120 may receive the design rule and may convert the same into a second vector. The design rule 20 may represent a rule, or rules, on an arrangement and form of design polygons. The design rule 20 may represent a minimum condition that allows patterning in the process.

For example, the design rule 20 may be a reference to be physically observed by the polygons in the semiconductor pattern image, which is required for successful patterning, and may include lengths and positions of the polygons, and the respective gaps among the polygons.

The design rule embedder 120 may convert the design rules for the respective polygons into vector values. The design rule embedder 120 may provide the second vector to the artificial intelligence model of the image generator 130 as an input.

Upon receiving the first vector and the second vector, the image generator 130 may generate one or more pattern images 30 that satisfy the patterning vulnerability and the design rule.

The image generator 130 may include various types of artificial intelligence-based image generating models. For example, the image generator 130 may include diffusion models (DMs), generative adversarial networks (GANs) model, variational auto encoder (VAE) model, and autoregressive models (Ams) model.

For example, the image generator 130 may generate at least one pattern image satisfying the patterning vulnerability and the design rule from random noise using a diffusion model. The patterning vulnerability and the design rule may be provided to semiconductor pattern image generating device 100 to be assessed, for example, by the patterning vulnerability embedder 110, to create one or more weak scores. For example, the first weak score and second weak score which were calculated according to different patterning vulnerability estimating indices based on various patterning vulnerabilities, the image generator 130 may generate at least one pattern image satisfying the first weak score and the second weak score.

The image generator 130 may generate polygons respectively satisfying design rules. The image generator 130 may generate patterns defined according to arrangement of the polygons and reflecting patterning vulnerability.

That is, the respective pattern images may include polygons having a pattern satisfying patterning vulnerability, and satisfying the design rule.

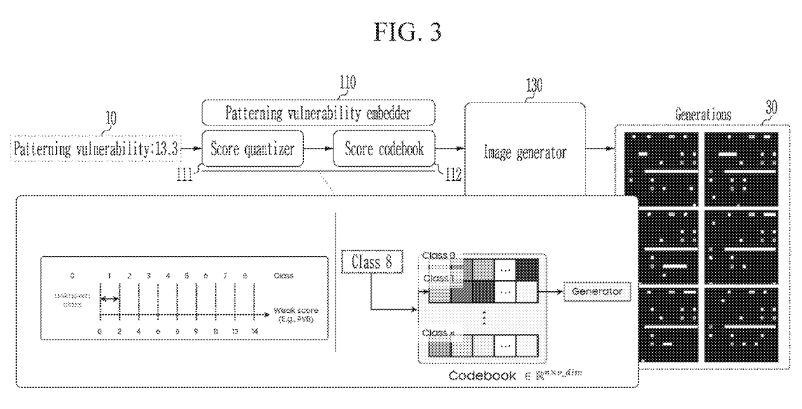

FIG. 3 illustrates an example patterning vulnerability embedder of FIG. 2 according to one or more embodiments.

Referring to FIG. 3, in a non-limiting example, the patterning vulnerability embedder 110 may include a score quantizer 111 and a score codebook 112.

In an example, the score quantizer 111 may quantize the weak score shown as a consecutive value and may define classes.

For example, the PVB-based weak score may have scores ranging from 0 to 14. The score quantizer 111 may quantize the weak score of 0 to 14 and may define the classes in a range of values from 1 to 8.

For example, when a PVB-based weak score of 13.3 is input, the score quantizer 111 may define its patterning vulnerability as class 8.

The score quantizer 111 may also define an unknown class. The unknown class may be used in situations in which there is an instruction or desire to not use the received patterning vulnerability, or in cases when no patterning vulnerability has been received. The score quantizer 111 may define another unknown class (which is class 0) as a class that is other than class 1 to class 9. The score quantizer 111 may determine the patterning vulnerability as an unknown class when not inputting the index of patterning vulnerability to the image generator 130.

In an example, the score codebook 112 may define a codebook including vector values corresponding to the classes. For example, when receiving PVB-based patterning vulnerability and defining the weak score as classes 0 to 8, the score codebook 112 may generate a codebook including vector values corresponding to class 0 to class 8.

The score codebook 112 may determine the weak score and the corresponding first vector based on the generated codebook. For example, when the input patterning vulnerability 10 is 13.3, the score quantizer 111 may assign class 8, and the score codebook 112 may determine the first vector corresponding to class 8 and may provide the same to the image generator 130.

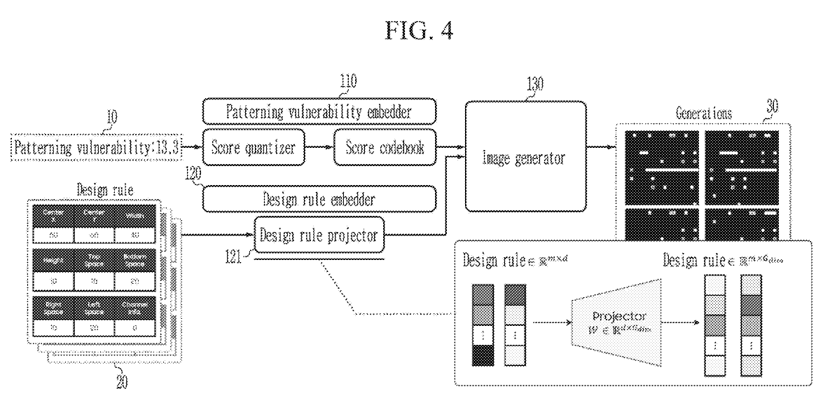

FIG. 4 illustrates an example design rule embedder of FIG. 2 according to one or more embodiments.

Referring to FIG. 4, in a non-limiting example, the design rule embedder 120 may include a design rule projector 121.

In an example, the design rule embedder 120 may receive the design rules for the polygons included in the pattern image. The design rule projector 121 may project the received design rule in a predetermined dimension and may generate a second vector. For example, the design rule projector 121 may have m-numbered samples, and may receive the design rule expressed in the d-dimensional space.

The design rule projector 121 may be expressed as a matrix W, and may perform a conversion of mapping data of the input design rule in a high-dimensional (or low-dimensional) feature space. The design rule projector 121 may output the second vector into a new vector space expressed as a new dimension (Gdim) through the conversion. The design rule projector 121 may provide the second vector to the artificial intelligence model of the image generator 130 as an input.

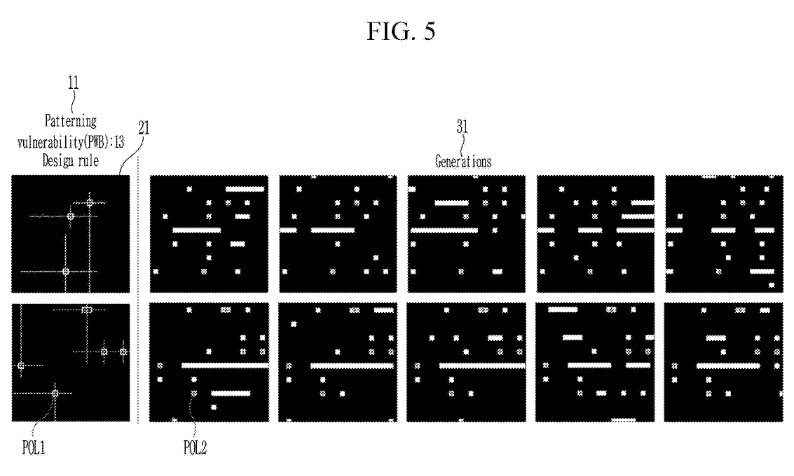

FIG. 5 illustrates example inputs and outputs according to one or more embodiments.

Referring to FIG. 5, in a non-limiting example, the patterning vulnerability 11 may be input as a PVB-based weak score of 13. The input design rule 21 may include a spaced distance and a position for each polygon POL1.

The generated pattern images 31 may satisfy the input patterning vulnerability 11, and may satisfy the design rule 21 to which the included polygon POL2 is input.

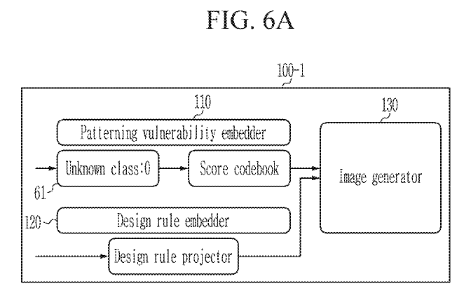

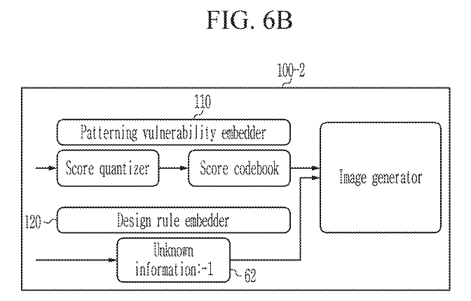

FIGS. 6A and FIG. 6B illustrate example devices with semiconductor pattern image generation according to one or more embodiments.

Referring to FIG. 6A, in a non-limiting example, a device for generating semiconductor pattern images 100-1 when ignoring patterning vulnerability and inputting the design rule is illustrated.

When the design rule is independently input, the pattern image generate device 100-1 may use the unknown class 61, for example, class 0 as an input to the patterning vulnerability embedder 110.

Referring to FIG. 6B, in a non-limiting example, a device for generating semiconductor pattern images 100-2 when ignoring the design rule and inputting patterning vulnerability to generate pattern images is illustrated.

When independently inputting the patterning vulnerability, the device for generating semiconductor pattern images 100-2 may use the unknown information 62 predefined in the design rule embedder 120, for example, -1, as an input.

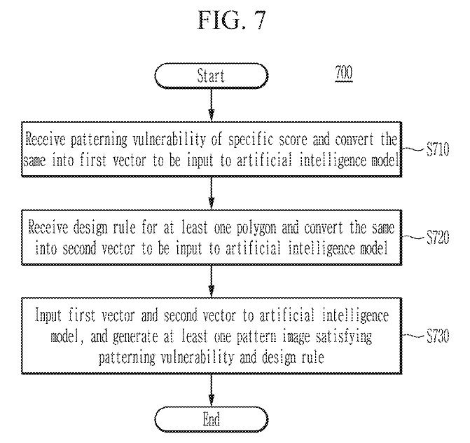

FIG. 7 illustrates an example method with semiconductor pattern image generation according to one or more embodiments. The method for generating semiconductor pattern images of FIG. 7 may be performed by the device with semiconductor pattern image generation 100 of FIG. 2.

Referring to FIG. 7, in a non-limiting example, in a method 700, a device with semiconductor pattern image generation (e.g., device 100) may receive patterning vulnerability of a specific score and may convert the same into the first vector to be input to the artificial intelligence model in operation S710.

The device may receive patterning vulnerability shown as a first weak score using the patterning vulnerability estimating index including a process variation band (PVB) and a normalized image log slope (NILS). A vector value corresponding to the received first weak score may be generated. The device may define the classes by quantizing the weak score shown as a continuous value.

In an example, the device may define the unknown class used when ignoring the received patterning vulnerability.

The device may define a codebook including vector values corresponding to classes. The first vector corresponding to the first weak score may be determined based on the codebook.

In an example, the device may simultaneously receive the respective weak scores provided using patterning vulnerability estimating indices as patterning vulnerabilities.

In an example, the device with semiconductor pattern image generation (e.g., device 100) may receive a design rule for at least one polygon and may convert that design rule into the second vector to be input to the artificial intelligence model in operation S720. The design rules for the respective polygons may be included in at least one pattern image.

In an example, the device may project the received design rule in a predetermined dimension and may generate a second vector. In operation S730, the first vector and the second vector may be input to the artificial intelligence model, which may generate at least one pattern image satisfying the patterning vulnerability and the design rule.

In an example, the device with semiconductor pattern image generation (e.g., device 100) may generate polygons satisfying the design rule, and may generate patterns defined by arrangement of the polygons and reflecting patterning vulnerability. The device may generate at least one pattern image using an artificial intelligence-based image generating model. For example, at least one pattern image may be generated that satisfy the patterning vulnerability and the design rule from random noise using a diffusion model.

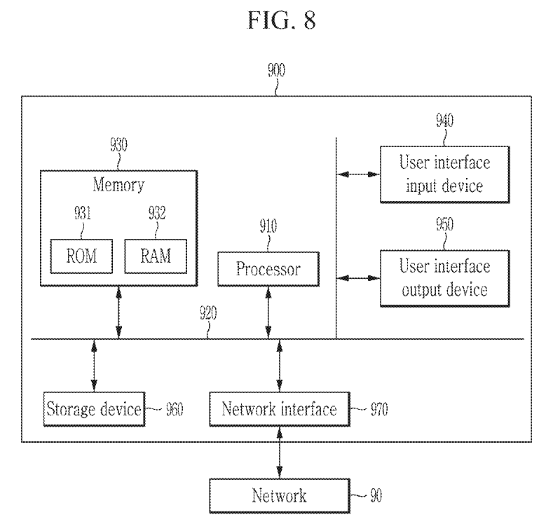

FIG. 8 illustrates an example electronic device according to one or more embodiments.

Referring to FIG. 8, in a non-limiting example, an electronic apparatus with semiconductor pattern image generation and method (e.g., method 700) may be implemented using an electronic device 900.

The electronic device 900 may include at least one of a processor 910, a memory 930, a user interface input device 940, a user interface output device 950, and a storage device 560 each communicating with a bus 920. The electronic device 900 may include a network interface 970 electrically connected to a network 90. The network interface 970 may transmit or may receive signals to/from other elements through the network 90.

The processor 910 may be configured to execute programs or applications to configure the processor 910 to control the electronic device 900 to perform one or more or all operations and/or methods involving providing of positional encoding to a neural network. The processor 910 may be implemented as various types of devices such as a micro controller unit (MCU), an application processor (AP), a central processing unit (CPU), a graphic processing unit (GPU), or a neural processing unit (NPU), and may be an arbitrary semiconductor device for executing instructions stored in the memory 930 or the storage device 960. The processor 910 may implement the function and methods described with reference to FIGS. 1 - FIG. 7.

The memory 930 may include computer-readable instructions. The processor 910 may be configured to execute computer-readable instructions, such as those stored in the memory 930, and through execution of the computer-readable instructions, the processor 910 may be configured to perform one or more, or any combination, of the operations and/or methods described herein. The memory 930 and storage device 960 may include various types of volatility or non-volatile storage media. For example, the memory may include a read-only memory (ROM) 931 and a random access memory (RAM) 932. In an example, the memory 930 may be disposed inside or outside the processor 910, and may be connected to the processor 910 through known various means.

In an example, at least some of the elements or functions of the device, method, and system semiconductor pattern image generation may be implemented with programs or software executed by the electronic device 900, and the programs or software may be stored in a computer readable medium.

In an example, at least some of the elements or functions of the device, method, and system with semiconductor pattern image generation may be implemented with hardware or circuits of the electronic device 900, and may be implemented with additional hardware or circuit electrically connected to the electronic device 900.

The electronic devices, memories, processors, neural networks, device 100, patterning vulnerability embedder 110, design rule embedder 120, image generator 130, electronic device 900, processor 910, a memory 930, user interface input device 940, user interface output device 950, storage device 960, and network interface 970 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term "processor" or "computer" may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device, comprising:
one or more processors comprising processing circuitry; and
a memory comprising one or more storage media storing instructions that, when executed individually or collectively by the one or more processors, cause the electronic device to:
convert a patterning vulnerability into a first vector;
convert a design rule into a second vector; and
generate one or more pattern images to satisfy the patterning vulnerability and the design rule based on the first vector and the second vector.

2. The device of claim 1, wherein the converting of the patterning vulnerability into the first vector comprises:
determining a first weak score from the patterning vulnerability using a patterning vulnerability estimating index, the patterning vulnerability estimating index being one of a process variation band (PVB) and a normalized image log slope (NILS); and
calculating a vector value corresponding to the determined first weak score.

3. The device of claim 2, wherein the calculating of the vector value comprises:
defining classes by quantizing one or more class weak scores, the class weak scores being defined as continuous values;
defining a codebook including class vector values corresponding to the classes; and
determining a first weak score and a corresponding first vector based on the codebook.

4. The device of claim 3, wherein the defining classes comprises:
defining an unknown class responsive to an absence of the patterning vulnerability to generate a default vector as the vector value.

5. The device of claim 1, wherein the converting of the patterning vulnerability into the first vector comprises: simultaneously receiving proposed weak scores as patterning vulnerabilities, the proposed weak scores being created using patterning vulnerability estimating indices.

6. The device of claim 1, wherein the execution of the instructions causes the electronic device to:
receive the design rules for respective polygons included in the one or more pattern image, and
project the design rule in a predetermined dimension to generate the second vector.

7. The device of claim 1, wherein the generating comprises:
generating polygons respectively satisfying the design rule, and
generating patterns defined by an arrangement of the polygons and reflecting the patterning vulnerability.

8. The device of claim 1, wherein the generating comprises:
generating the one or more pattern images using an artificial intelligence-based image generating model.

9. The device of claim 8, wherein the generating further comprises:
generating the one or more pattern images satisfying the patterning vulnerability and the design rule from random noise using a diffusion model.

10. A processor-implemented method, the method comprising:
converting a received patterning vulnerability into a first vector;
converting a received design rule into a second vector; and
generating one or more pattern images satisfying the patterning vulnerability and the design rule with the first vector and the second vector.

11. The method of claim 10, wherein the converting of the received patterning vulnerability comprises:
determining a first weak score from the received patterning vulnerability using a patterning vulnerability estimating index, the patterning vulnerability estimating index being one of a process variation band (PVB) and a normalized image log slope (NILS); and
calculating a vector value corresponding to the determined first weak score.

12. The method of claim 11, wherein the calculating comprises:
defining classes by quantizing one or more class weak scores, the class weak scores being defined as continuous values;
defining a codebook including class vector values corresponding to the classes; and
determining a first weak score and a corresponding first vector based on the codebook.

13. The method of claim 12, wherein the defining of the classes comprises:
defining an unknown class responsive without the received patterning vulnerability to generate a default vector as the vector value.

14. The method of claim 10, wherein the converting of the received patterning vulnerability into the first vector comprises:
simultaneously receiving proposed weak scores as received patterning vulnerabilities, the proposed weak scores being created using patterning vulnerability estimating indices.

15. The method of claim 10, wherein the converting of the received design rule into the second vector comprises:
receiving the design rules for respective polygons included in the one or more pattern images; and
projecting the design rule in a predetermined dimension to generate the second vector.

16. The method of claim 10, wherein the generating comprises:
generating polygons respectively satisfying the received design rule, and
generating patterns defined by an arrangement of the polygons and reflecting the patterning vulnerability.

17. The method of claim 10, wherein the generating comprises:
generating the one or more pattern image using an artificial intelligence-based image generating model.

18. The method of claim 17, wherein the generating further comprises:
generating the one or more pattern images satisfying the received patterning vulnerability and the received design rule from random noise using a diffusion model.

19. A system, comprising:
a semiconductor pattern image generator configured to generate semiconductor pattern images, the semiconductor pattern image generator including an artificial intelligence model for generating a patterning candidate group including at least one pattern image satisfying a design rule and a patterning vulnerability; and
a simulator for performing a process simulation using the patterning candidate group,
wherein the system is further configured to adjust process variables responsive to results of the simulation.

20. The system of claim 19, wherein the semiconductor pattern image generator comprises:
one or more processors comprising processing circuitry; and
a memory comprising one or more storage media storing instructions that, when executed individually or collectively by the one or more processors, cause the semiconductor pattern image generator to:
convert a patterning vulnerability into a first vector;
convert a design rule into a second vector;
generate one or more pattern images to satisfy the patterning vulnerability and the design rule based on the first vector and the second vector; and
generate, though an artificial intelligence-based model, one or more semiconductor pattern images.
